(19) United States
(12) Patent Application Publication
(10) Pub. No.: US 2023/0362602 A1
(43) Pub. Date: Nov. 9, 2023

(54) SYSTEM AND METHOD FOR CONFIGURING EEC FOR SERVICE PROVISIONING AND EAS DISCOVERY

(71) Applicant: Samsung Electronics Co., Ltd., Suwon-si (KR)

(72) Inventors: Nishant GUPTA, Bangalore (IN); Basavaraj Jayawant PATTAN, Bangalore (IN)

(21) Appl. No.: 18/245,996

(22) PCT Filed: Sep. 17, 2021
(86) PCT No.: PCT/KR2021/012890

§ 371 Date: Mar. 20, 2023

(30) Foreign Application Priority Data
Sep. 22, 2020 (IN) 202041041060
Sep. 8, 2021 (IN) 202041041060

(51) Int. Cl. H04W 4/20

(52) U.S. Cl. CPC H04W 4/20; H04W 84/042

(57) ABSTRACT

The present disclosure relates to a pre-5th generation (5G) or 5G communication system to be provided for supporting higher data rates beyond 4th generation (4G) communication system such as long term evolution (LTE). The embodiments disclose a method for configuring an Edge Enabler Client for service provisioning and Edge Application Server discovery by a UE, the method comprising: sending, by the Edge Enabler Client in the UE, a service request to an edge server, wherein the edge server is one of an Edge Configuration Server and an Edge Enabler Server; determining by the edge server, whether a UE specific information is present in the service request, the UE specific information comprises information of at least one application client available in the UE; and rejecting by the edge server, the received request with a rejection cause in response to determining that the UE specific information is not present in the request.

This application is a 371 of International Application No. PCT/KR2021/012890 filed on Sep. 17, 2021, which claims priority to India Patent Application No. 202041041060 filed on Sep. 22, 2020, and India Patent Application No. 202041041060 filed on Sep. 8, 2021, the disclosures of which are herein incorporated by reference in their entirety.

### BACKGROUND

### 1. Field

The present invention relates to Edge computing and more specifically relates a system and method for configuring Edge Enabler Client (EEC) for service provisioning and Edge Application Server (EAS) discovery.

### 2. Description of Related Art

To meet the demand for wireless data traffic having increased since deployment of 4th generation (4G) communication systems, efforts have been made to develop an improved 5th generation (5G) or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

In general, with the advent of Edge computing capabilities, applications on a User Equipment (UE) are more responsive and provide features, which are not possible without the low latency and fast processing capabilities provided by the Edge computing systems. Applications like VR gaming and network assisted processing heavily rely on Edge computing capabilities. The Applications provide certain features without the use of Edge computing systems, while certain features are not serviceable without Edge computing. But due to limited resources and high operational costs, hosting applications on the edge (called Edge Application Servers) incur more cost; based on which the edge computing service provider and application provider may selectively choose the deployments of the edge computing services and applications on the edge, respectively.

Therefore, to determine the availability of the Edge computing service and Edge Application Servers (EAS) the system utilizes an Edge Configuration Server (ECS) and an Edge Enabler Server (EES) respectively. The algorithms used by these servers are usually proprietary and can require a wide variety of input parameters such as User Equipment (UE) location, type of the UE (e.g. V2X UE or any other purpose built UE), information of the Application Clients (ACs) installed on the UE, etc. Currently there is no standard method available for an ECS or an EES to configure the EEC running on the UE as to what information is needed by the respective servers in order to provide relevant service provisioning or EAS discovery information to the UE.

Thus, it is desired to address the above mentioned disadvantages or other shortcomings or at least provide a useful alternative.

### SUMMARY

The principal object of the embodiments herein is to provide a system and method for configuring Edge Enabler Client (EEC) for service provisioning and Edge Application Server (EAS) discovery.

Accordingly, the embodiments herein discloses a method for configuring Edge Enabler Client (EEC) in a User Equipment (UE) for service provisioning and Edge Application Server discovery, the method comprising: sending, by the Edge Enabler Client in the UE, a service request to an edge server, wherein the edge server is one of an Edge Configuration Server (ECS) and an Edge Enabler Server (EES); determining by the edge server, whether a UE specific information is present in the service request, wherein the UE specific information comprises information of at least one application client available in the UE; and rejecting by the edge server, the received request with a rejection cause in response to determining that the UE specific information is not present in the request.

In an embodiment, the method further comprises receiving, by the EEC in the UE, a rejection message with the rejection cause from the edge server indicating requirement of the UE specific information to be included in the request to the edge server; and re-sending by the EEC, the service request comprising the UE specific information required by the edge server based on the rejection cause.

In an embodiment, the service request is one of a service provisioning request and a service provisioning subscription request in response to determining that the edge server is the Edge Configuration Server.

In yet another embodiment the service request is one of an edge application server (EAS) discovery and a EAS discovery subscription request in response to determining that the edge server is the Edge Enabler Server.

In an embodiment the UE specific information is pre-configured in the EEC of the UE.

In another embodiment, the UE specific information is provided by one of the application client and the user of the UE.

Accordingly, the embodiments herein disclose an Edge computing system for configuring an Edge Enabler Client, the Edge computing system comprising: a User Equipment; and an Edge Server; the UE comprising the Edge Enabler Client configured to: send a service request to an edge server, wherein the edge server is one of an Edge Configuration Server and an Edge Enabler Server; determine whether a UE specific information is present in the service request, wherein the UE specific information comprises information of at least one application client (114) available in the UE; and reject the received request with a rejection cause in response to determining that the UE specific information is not present in the request.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

According to the disclosure, there is improvements in and relating to configuring an edge enabler client (EEC) for service provisioning and an edge application server (EAS) discovery.

### BRIEF DESCRIPTION OF THE DRAWINGS

The method and the device illustrated in the accompanying drawings, throughout which reference letters indicate corresponding parts in the various figures. The embodiments herein will be better understood from the following description with reference to the drawings, in which:

FIG. 1 is a block diagram illustrating application architecture for enabling edge applications in 3GPP networks, according to the prior art;

FIG. 2 is a block diagram illustrating a scenario of providing service provisioning information to the UE, according to the prior art;

FIG. 3 is a block diagram illustrates a scenario of providing EAS information to the UE, according to the prior art;

FIG. 4 is a block diagram, illustrating an electronic device for configuring EEC for service provisioning and EAS discovery; and

FIG. 5a is a sequence diagram, illustrating a sequence for configuring the Edge Enabler Client (412) for service provisioning, according to an embodiment as disclosed herein;

FIG. 5b is a sequence diagram, illustrating a sequence for configuring the Edge Enabler Client (412) for EAS discovery, according to an embodiment as disclosed herein.

FIG. 6 is a flow diagram, illustrating a flow 600 for configuring the Edge Enabler Client (412) for service provisioning and EAS discovery, according to an embodiment as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly the embodiment herein is to provide a system and method for configuring Edge Enabler Client (EEC) for service provisioning and Edge Application Server (EAS) discovery. The proposed method is used to determine the availability of the Edge computing service and Edge Application Servers (EAS) the system utilizes an Edge Configuration Server (ECS) and an Edge Enabler Server (EES) respectively. The algorithms used by these servers are usually proprietary and can require a wide variety of input parameters such as User Equipment (UE) location, type of the UE, information of the application clients installed on the UE, etc. Currently there is no standard method available for an ECS or an EES to configure the EEC running on the UE as to what information is needed by the respective servers in order to provide relevant service provisioning or EAS discovery information to the UE. The proposed method provides methods to configure the EEC appropriately for communication with the ECS and the EES.

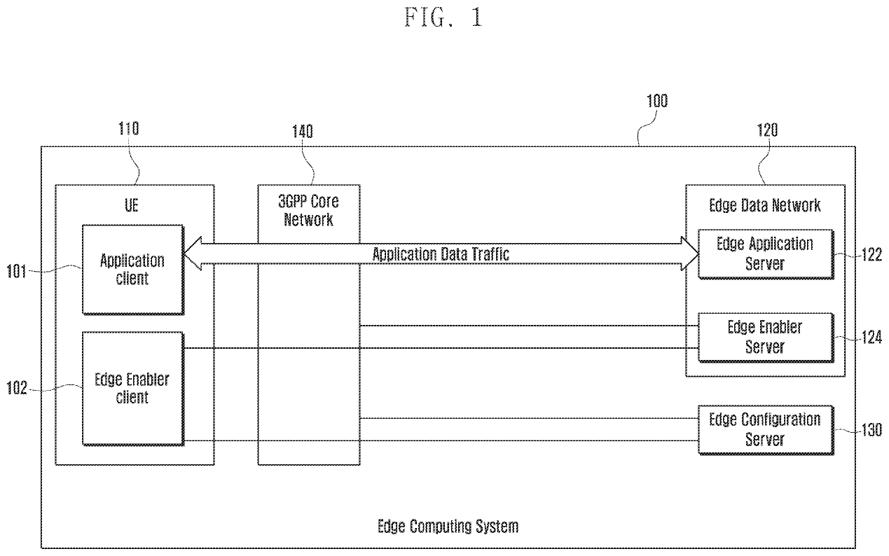

Referring now to the drawings, and more particularly to FIGS. 1 through 6, where similar reference characters denote corresponding features consistently throughout the figures, there are shown preferred embodiments.

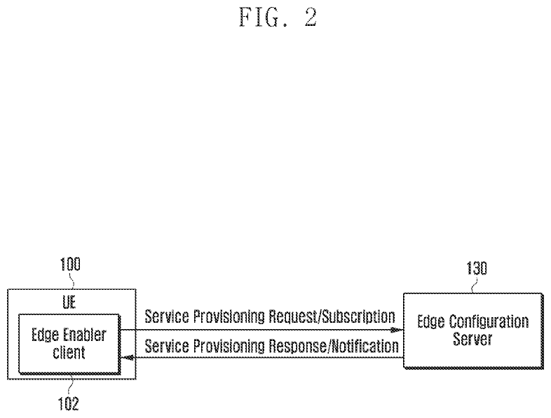

FIG. 1 is a block diagram illustrating application architecture for enabling edge applications in 3GPP networks, according to the prior art. As seen in FIG. 1, an edge computing system (100) comprises a UE (110), communicating with an Edge data network (120) and an Edge Configuration Server (ECS) (130) over a 3GPP core Network (140). The UE (110) comprises an Edge Enabler Client (102) and Application Clients (104). The Edge data network (120) comprises Edge Application Servers (122) and Edge Enabler Servers (124). The Edge Configuration Server (130) is responsible for providing relevant configurations to the Edge Enabler Client (102) in the UE (110), such that Edge Enabler Client (102) is able to determine an availability of edge computing service and connect to the available Edge Enabler Servers (124). The process of determining the availability of edge computing service and connecting to the available Edge Enabler Servers (124) is called as service provisioning and is depicted in FIG. 2.

As seen in FIG. 2, the Edge Enabler Client (102) sends the service provisioning request to the Edge Configuration Server (130). In response to the service provisioning request, the Edge Configuration Server (130) sends the service provisioning response.

Similarly the Edge Enabler Client (102) sends the service provisioning subscription request to the Edge Configuration Server (130). In response to the service provisioning subscription request, the Edge Configuration Server (130) sends the service provisioning subscription response, which later follows with a service provisioning notification when a related event occurs.

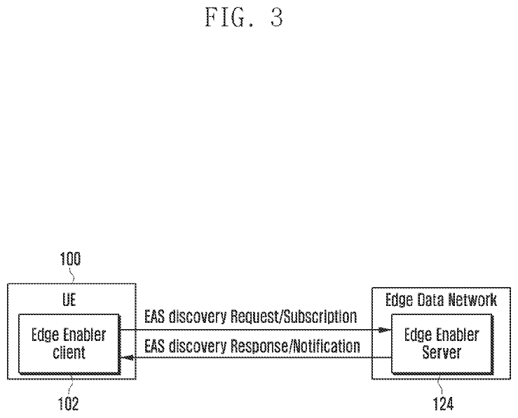

FIG. 3 is a block diagram illustrating a scenario of providing Edge Application Server (122) information to the UE (110), according to the prior art.

Referring to the FIG. 3 consider a proposed method, wherein the Edge Enabler Server (124) is responsible for providing relevant configurations to the Edge Enabler Client (102) in the UE (110), such that Edge Enabler Client (102) is able to determine the availability of Edge Application Servers (122) and enable Application Clients (104) to connect. The process of determining the availability of the Edge Application Servers (122) and enabling application clients to connect to the Edge Application Servers (120) is termed as EAS discovery.

As seen in FIG. 3, the Edge Enabler Client (102) sends the EAS discovery request to the Edge Enabler Server (124). In response to the EAS discovery request, the Edge Enabler Server (124) sends the EAS discovery response.

Similarly the Edge Enabler Client (102) sends the EAS discovery subscription request to the Edge Enabler Server (124). In response to the EAS discovery subscription request, the Edge Enabler Server (124) sends the EAS discovery subscription response, which later follows with a EAS discovery notification when a related event occurs.

Both, the Edge Configuration Server (130) and the Edge Enabler Server (124), may apply proprietary method or algorithm to filter and provide the edge computing service and the EAS information to the UE (110). The Edge Configuration Server (130) and the Edge Enabler Server (124) may use, but not limited to, a location of the UE (110), a type of the UE (110), and information of application clients installed on the UE (110) etc. However, the existing methods fail in case where any piece of essential information required for processing a service request is missing from a received request. For the Edge Enabler Client (102), which is oblivious of the algorithms used by the Edge Configuration Server (130) or the Edge Enabler Server (124), it is important to know what information should be provided in order to obtain the required service provisioning or EAS information successfully. Thus the proposed method provides multiple options for obtaining the required service provisioning and the EAS information successfully.

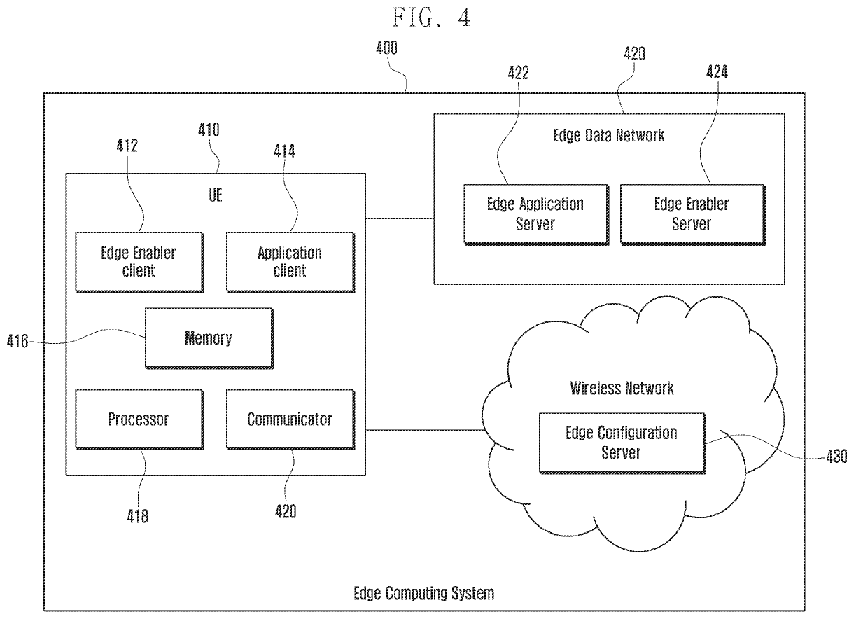

FIG. 4 is a block diagram of an Edge computing environment (400) for configuring Edge Enabler Client (412) for service provisioning and EAS discovery, according to an embodiment as disclosed herein.

As seen in FIG. 4, the edge computing environment (400) comprises a UE (410), communicating with an Edge data network (420) and an Edge Configuration Server (ECS) (430). The Edge data network (420) comprises Edge Application Servers (422) and Edge Enabler Servers (424).

The UE (400) may be, for example, but not limited, to a mobile device, a cellular phone, a smart phone, a Personal Digital Assistant (PDA), a tablet computer, a laptop computer, an Internet of things (IoT) device, an Artificial intelligent (AI) device or the like.

In an embodiment, the UE (410) includes an Edge Enabler Client (412), a plurality of Application Clients (414), a memory (416), a processor (418), and a communicator (420).

The memory (416) stores instructions to be executed by the processor (418) for configuring the Edge Enabler Client (412) for service provisioning and EAS discovery. The memory (412) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (412) may, in some examples, be considered a non-transitory storage medium. The term “non-transitory” may indicate that the storage medium is not embodied in a carrier wave or a propagated signal. However, the term “non-transitory” should not be interpreted that the memory (412) is non-movable. In some examples, the memory (412) can be configured to store larger amounts of information than the memory. In certain examples, a non-transitory storage medium may store data that can, over time, change (e.g., in Random Access Memory (RAM) or cache). The memory (412) can be an internal storage or it can be an external storage unit of the electronic device (300), a cloud storage, or any other type of external storage.

In an embodiment, the processor (418) communicates with the memory (416), the communicator (420). The processor (418) is configured to execute instructions stored in the memory (416) for configuration the Edge Enabler Client (412) for service provisioning and EAS discovery The processor (418) may include one or a plurality of processors, may be a general purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

In an embodiment, the communicator (420) is configured for communicating internally between internal hardware components and with external devices via one or more networks. The communicator (420) includes an electronic circuit specific to a standard that enables wired or wireless communication.

The different option for configuring the Edge Enabler Client (410) for service provisioning and EAS discovery provided by the proposed method and system are disclosed below.

In an embodiment the Edge Configuration Server (430) related information (such as IP address) is preconfigured in the Edge Enabler Client (412) or the UE (410) at the time of manufacturing of the UE (410) or at the time of Edge Enabler Client (412) development or installation. In such a deployment, configurations related to the information needed by the Edge Configuration Server (430) such as whether the information related to application clients installed on the UE (410) is needed by the Edge Configuration Server (430) or not, is preconfigured along with the other Edge Configuration Server (430) related information. While creating a service provisioning request, the Edge Configuration Server (430) follows the available configuration rules.

In another embodiment, the Edge Configuration Server (430) related information (such as IP address) is provided by the application client (414) to the Edge Enabler Client (412) or the UE (410). In such a deployment, configurations related to the information needed by the Edge Configuration Server (430) such as whether the information related to application clients (414) installed on the UE (400) is needed by the Edge Configuration Server (430) or not is provided by the application client (414) with the other Edge Configuration Server (430) related information to the Edge Enabler Client (412). While creating a service provisioning request, the Edge Enabler Client (412) follows the configuration rules provided by the application client.

In yet another embodiment, the Edge Configuration Server (430) rejects the received service provisioning request if the service provisioning request does not include the required information such as information related to application clients (414) installed on the UE (410). The rejection includes an appropriate rejection code understandable by the Edge Enabler Client (412), which indicates to the Edge Enabler Client (412) as to what information is essentially (mandatorily) needed by the Edge Configuration Server (430) such as information related to application clients (414) installed on the UE (410). The Edge Configuration Server (430) may include multiple rejection codes in case multiple pieces of information are missing from the request. A granularity of the rejection codes can be at the level of individual pieces of information related to the application client such as the required KPIs, whether service continuity is required by the application client (104) or not, etc. On receiving such rejection code(s), the Edge Enabler Client (412) may resubmit the request including the information required by the Edge Configuration Server (430) such as information related to application clients installed on the UE (410) as deducted by the rejection code. The Edge Enabler Client (412) may store this deduction for future use. In an alternate embodiment, multiple such codes are combined in a single rejection code, if required.

Table 1 below shows a service provisioning response/subscription response sent from the Edge Configuration Server (430) to the Edge Enabler Client (412).

TABLE 1

| Information element | Status | Description |
|---|---|---|
| Successful response | O | Indicates that the request/subscription |
| | | request was successfully processed. |
| >. . . | . . . | Information related to the EDNs or |
| | | subscription |
| Failure response | O | Indicates that the request/subscription |
| | | request failed. |
| >Cause/rejection | O | Rejection code indicating that the |
| reason/rejection code | | information about the application client |
| | | installed on the UE is mandatory to be |
| | | included in the request. |
| >Cause/rejection | O | Other such rejection code. |
| reason/rejection code | | |

Table (1) Service Provisioning Response/Subscription Response

In an embodiment the Edge Configuration Server (430) related information is provided by a core network to the Edge Enabler Client (410). The core network (session management function, or the SMF) provides the IP address, Port and/or Fully Qualified Domain Name information of the ECS as part of Protocol Configuration Options (PCO) when the UE (410) registers with the core network. When providing the Edge Configuration Server (430) IP address, Port and/or FQDN information the PCO also includes configuration(s) about what information is essentially (mandatorily) needed by the Edge Configuration Server (430) such as information related to application clients installed on the UE (410) to successfully process the request received from the Edge Enabler Client (410). Further, when the Edge Enabler Client (410) is creating the service provisioning request, it takes into account the information provided in the PCO message. This method saves a wasted request response cycle of the earlier method.

In another embodiment, for the EAS discovery related interaction with the Edge Enabler Server (424), following methods are used to configure the Edge Enabler Client (410) appropriately:

In another embodiment, the Edge Enabler Server (430) rejects the EAS discovery request if the EAS discovery request does not include the required information, such as information related to application clients (114) installed on the UE (410). The rejection includes an appropriate rejection code understandable by the Edge Enabler Client (412), which indicates to the Edge Enabler Client (412) as to what information is essentially (mandatorily) needed by the Edge Enabler Server (424) such as information related to application clients installed on the UE (410). The Edge Enabler Server (424) may includes multiple rejection codes in case multiple pieces of information are missing from the request. The granularity of the rejection codes can be at the level of individual pieces of information related to the application client such as the required KPIs, whether service continuity is required by the application client (114) or not, etc. On receiving such rejection code(s), the Edge Enabler Client (412) resubmit the request including the information required by the Edge Enabler Server (424) such as information related to application clients (414) installed on the UE (410). The Edge Enabler Client (412) stores this deduction for future use. In an alternate embodiment, multiple such codes can be combined in a single rejection code, if required.

Table 2 below illustrated the EAS discovery response/subscription response sent from the Edge Enabler Server (424) to the Edge Enabler Client (412).

TABLE 2

| Information element | Status | Description |
|---|---|---|
| Successful response | O | Indicates that the request/subscription |
| | | request was successfully processed. |
| . . . | . . . | Information related to the EASs or |
| | | subscription |
| Failure response | O | Indicates that the request/subscription |
| | | request failed. |
| >Cause/rejection | O | Rejection code indicating that the |
| reason/rejection code | | information about the application client |
| | | installed on the UE is mandatory to be |
| | | included in the request. |
| >Cause/rejection | O | Other such rejection code. |
| reason/rejection code | | |

Table (2) EAS discovery response/subscription response In yet another embodiment, where service provisioning response includes information about Edge Enabler Server (424) IP address, port and/or FQDN, is retrieved by the Edge Enabler Client (410) from the Edge Configuration Server (430) or provided by the Edge Configuration Server (424) to the Edge Enabler Client (410) in a service provisioning notification. When providing the Edge Enabler Server (424) IP address, Port and/or FQDN information the Edge Configuration Server (430) also includes configuration(s) about what information is essentially (mandatorily) needed by the Edge Enabler Server (424) (such as information related to application clients installed on the UE (410) to successfully process the EAS discovery requests received from the Edge Enabler Client (410).

Table 3 below illustrates the Service provisioning response/notification sent from Edge Configuration Server (430) to the Edge Enabler Client (412).

TABLE 3

| Information element | Status | Description |
|---|---|---|
| List of EDN configuration | M | List of Edge Data Networks. |
| information | | |
| >EDN connection | M | Information required by the UE |
| information | | to establish connection with |
| (NOTE 1) | | the Edge Data Network. |
| >>DNN/APN | M | Data Network Name/Access |
| | | Point Name |
| >>S-NSSAI | O | Network Slice information |
| >>EDN Service Area | O | EDN service area information. |
| (NOTE 2) | | The service area information |
| | | is a list of Cell list or List |
| | | of TA, PLMN IDs |
| >List of Edge | M | List of Edge Enabler Servers of |
| Enabler Servers | | the Edge Data Network. |
| >>EES Endpoint | M | The endpoint address (e.g. URI, |
| | | IP address) of the EES |
| >>Application | M | Indicates if it is mandatory for |
| Client information | | Edge Enabler Client to include |
| indication | | information about the application |
| | | clients installed on the UE in |
| | | the EAS discovery messages when |
| | | interacting with this EES. |
| >>List of required | O | List of information needed by |
| input information | | the EES to process the EAS |
| | | discovery request. |
| >>ECSP info | O | Information for Edge Computing |
| | | Service Provider |
| >Lifetime | O | Time duration for which the EDN |
| | | configuration information is |
| | | valid and supposed to be cached |
| | | in the EEC. |

Table (3) Service provisioning response/notification In an alternate representation, the presence of the indication would mean that it is necessary to include information about the application clients installed on the UE (410) in the EAS discovery message when sending a request to the Edge Enabler Server (424), while, absence of the indication would mean that it is not mandatory. Names of the information elements used in the invention are just for illustration purposes and different names can be used to convey the same indications to the Edge Enabler Client (412), enabling it to construct the requests appropriately.

Although the FIG. 4 shows various hardware components of the edge computing system (400) is to be understood that other embodiments are not limited thereon. In other embodiments, the edge computing system (400) may include less or more number of components. Further, the labels or names of the components are used only for illustrative purpose and does not limit the scope of the invention. One or more components can be combined together to perform same or substantially similar function to configuring the Edge Enabler Client (412) for service provisioning and EAS discovery.

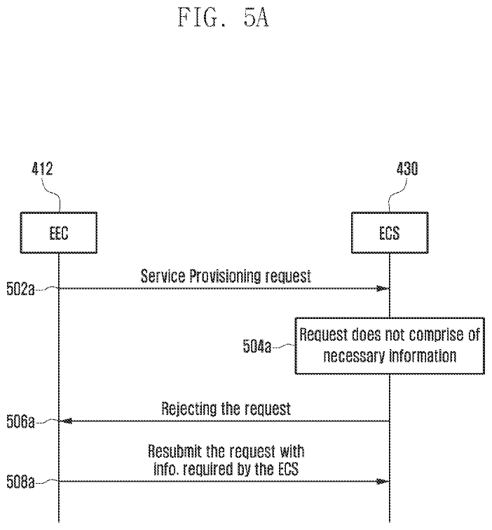

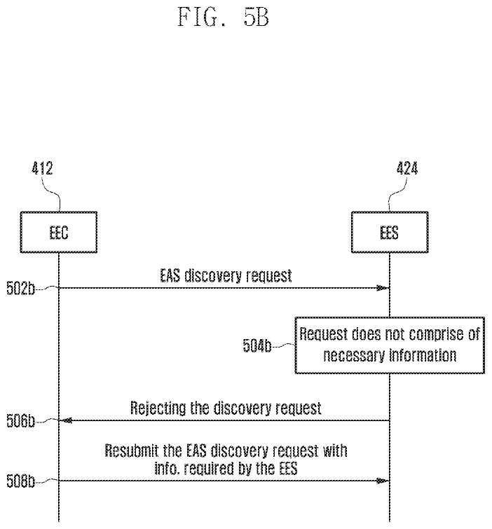

FIG. 5a is a sequence diagram, illustrating a sequence for configuring the Edge Enabler Client (412) for service provisioning, according to an embodiment as disclosed herein.

As seen in FIG. 5a, at 502a, Edge Enabler Client (412) sends the service provisioning request to the Edge Configuration Server (430). At 504a, the Edge Configuration Server (430) determines that the service provisioning request received does not include the required information such as information related to application clients (414) installed on the UE (410). At 506a, the Edge Configuration Server (430) rejects the service provisioning request comprising an appropriate rejection code understandable by the Edge Enabler Client (412), wherein the rejection does indicates to the Edge Enabler Client (412) as to what information is essentially (mandatorily) needed by the Edge Configuration Server (430) such as information related to application clients (414) installed on the UE (410). The Edge Configuration Server (430) may include multiple rejection codes in case multiple pieces of information are missing from the request. A granularity of the rejection codes can be at the level of individual pieces of information related to the application client such as the required KPIs, whether service continuity is required by the application client (104) or not, etc. At 508a, on receiving such rejection code(s), the Edge Enabler Client (412) resubmits the service provisioning request including the information required by the Edge Configuration Server (430) such as information related to application clients installed on the UE (410) as deducted by the rejection code. In an alternate embodiment, multiple such codes are combined in a single rejection code, if required.

In an alternate embodiment, at 502a, Edge Enabler Client (412) sends the service provisioning subscription request to the Edge Configuration Server (430).

FIG. 5b is a sequence diagram, illustrating a sequence for configuring the Edge Enabler Client (412) for EAS discovery, according to an embodiment as disclosed herein.

As seen in FIG. 5b, at 502b, the Edge Enabler Client (412) sends the EAS discovery request to the Edge Enabler Server (424). At 504b, the Edge Enabler Server (424) determines that the EAS discovery request received does not include the required information such as information related to application clients (414) installed on the UE (410). At 506b, the Edge Enabler Server (424) rejects the EAS discovery request comprising an appropriate rejection code understandable by the Edge Enabler Client (412), wherein the rejection does indicates to the Edge Enabler Client (412) as to what information is essentially (mandatorily) needed by the Edge Enabler Server (424) such as information related to application clients (414) installed on the UE (410). The Edge Enabler Server (424) may include multiple rejection codes in case multiple pieces of information are missing from the request. A granularity of the rejection codes can be at the level of individual pieces of information related to the application client such as the required KPIs, whether service continuity is required by the application client (104) or not, etc. At 508b, on receiving such rejection code(s), the Edge Enabler Client (412) resubmits the EAS discovery request including the information required by the Edge Enabler Server (424) such as information related to application clients installed on the UE (410) as deducted by the rejection code. In an alternate embodiment, multiple such codes are combined in a single rejection code, if required.

In an alternate embodiment, at 502b, the Edge Enabler Client (412) sends the EAS discovery subscription request to the Edge Enabler Server (424).

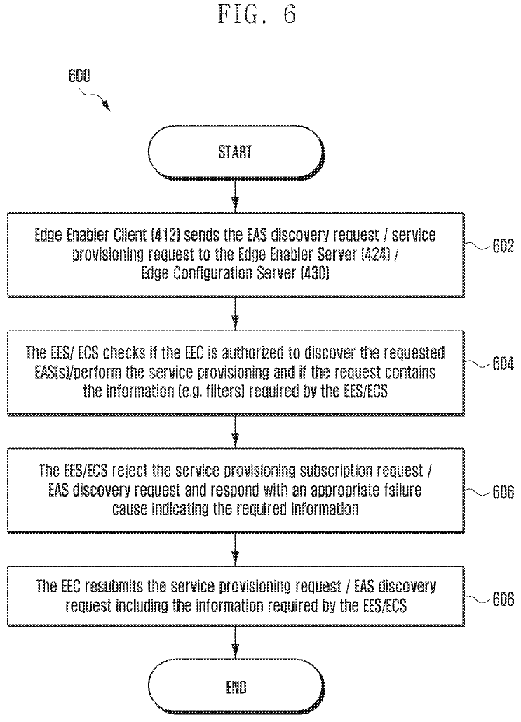

FIG. 6 is a flow diagram, illustrating a flow 600 for configuring the Edge Enabler Client (412) for service provisioning and EAS discovery, according to an embodiment as disclosed herein.

As seen in FIG. 6 at 602, the Edge Enabler Client (412) sends the EAS discovery request/service provisioning request to the Edge Enabler Server (424)/Edge Configuration Server (430). At 604, upon receiving upon receiving the request from the Edge Enabler Client (412), the Edge Enabler Server (424)/Edge Configuration Server (430) checks if the Edge Enabler Client (412) is authorized to discover the requested EAS(s)/perform the service provisioning.

If the Edge Enabler Server (424)/Edge Configuration Server (430) is unable to determine the EAS information/service provisioning information using the inputs in service EAS discovery request/provisioning subscription request, the UE-specific service information at the Edge Enabler Server (424)/Edge Configuration Server (430) or the ECSP policy, then at 606 the Edge Enabler Server (424)/Edge Configuration Server (430) reject the EAS discovery request/service provisioning request and respond with an appropriate rejection cause. In an embodiment, the Edge Enabler Server (424)/Edge Configuration Server (430) sends the rejection message comprising appropriate rejection code understandable by the Edge Enabler Client (412), wherein the rejection does indicates to the Edge Enabler Client (412) as to what information is essentially (mandatorily) needed by the Edge Enabler Server (424)/Edge Configuration Server (430) such as information related to application clients (414) installed on the UE (410).

At 608, on receiving such rejection code(s), the Edge Enabler Client (412) resubmits the EAS discovery request/service provisioning request including the information required by the Edge Enabler Server (424)/Edge Configuration Server (430) such as information related to application clients installed on the UE (410) as deducted by the rejection code.

In another embodiment, the flow as described in FIG. 6 applies to the service provisioning subscription request/EAS discovery subscription request sent by the Edge Enabler Client (412) to the Edge Enabler Server (424)/Edge Configuration Server (430).

The terms cause, code, rejection cause, rejection code, failure cause, failure code are used interchangeably, referring to the reason why the edge server rejected the request from the Edge Enabler Client (412).

The various actions, acts, blocks, steps, or the like in the flow diagram 600 may be performed in the order presented, in a different order or simultaneously. Further, in some embodiments, some of the actions, acts, blocks, steps, or the like may be omitted, added, modified, skipped, or the like without departing from the scope of the invention.

Forgoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1-12. (canceled)

13. A method performed by a user equipment (UE) configured with an edge enabler client (EEC) in a communication system, the method comprising:
transmitting, to an edge server, a service request; and
in case that the edge server is unable to determine information needed to process the service request, receiving, from the edge server, a response message including a failure cause,
wherein the failure cause indicates a cause of failure of the service request.

14. The method of claim 13, further comprising:
transmitting, to the edge server, the service request including information required by the edge server based on the failure cause.

15. The method of claim 13,
wherein the edge server is one of an edge configuration server (ECS) or an edge enabler server (EES).

16. The method of claim 13,
wherein, in case that the edge server is an edge configuration server (ECS), the service request is one of a service provisioning request or a service provisioning subscription request.

17. The method of claim 13,
wherein, in case that the edge server is an edge enabler server (EES), the service request is one of an edge application server (EAS) discovery or a EAS discovery subscription request.

18. A method performed by an edge server in a communication system, the method comprising:
receiving, from a user equipment (UE), a service request;
determining information needed to process the service request based on information included in the service request; and
in case that the edge server is unable to determine information needed to process the service request, transmitting, to the UE, a response message including a failure cause,
wherein the failure cause indicates a cause of failure of the service request.

19. The method of claim 18,
receiving, from the UE, the service request including information required by the edge server based on the failure cause.

20. The method of claim 18,
wherein the edge server is one of an edge configuration server (ECS) or an edge enabler server (EES).

21. The method of claim 18,
wherein, in case that the edge server is an edge configuration server (ECS), the service request is one of a service provisioning request or a service provisioning subscription request.

22. The method of claim 18,
wherein, in case that the edge server is an edge enabler server (EES), the service request is one of an edge application server (EAS) discovery or a EAS discovery subscription request.

23. A user equipment (UE) configured with an edge enabler client (EEC) in a communication system, the UE comprising:
a transceiver; and
a processor configured to:
transmit, to an edge server via the transceiver, a service request, and
in case that the edge server is unable to determine information needed to process the service request, receive, from the edge server, a response message including a failure cause,
wherein the failure cause indicates a cause of failure of the service request.

24. The UE of claim 23,
wherein the processor is further configured to:
transmit, to the edge server, the service request including information required by the edge server based on the failure cause.

25. The UE of claim 23,
wherein the edge server is one of an edge configuration server (ECS) or an edge enabler server (EES).

26. The UE of claim 23,
wherein, in case that the edge server is an edge configuration server (ECS), the service request is one of a service provisioning request or a service provisioning subscription request.

27. The UE of claim 23,
wherein, in case that the edge server is an edge enabler server (EES), the service request is one of an edge application server (EAS) discovery or a EAS discovery subscription request.

28. An edge server in a communication system, the edge server comprising:
a transceiver; and
a processor configured to:
receive, from a user equipment (UE), a service request,
determine, information needed to process the service request based on information included in the service request, and
in case that the edge server is unable to determine information needed to process the service request, transmit, to the UE, a response message including a failure cause,
wherein the failure cause indicates a cause of failure of the service request.

29. The edge server of claim 28,
wherein the processor is further configured to:
receive, from the UE, the service request including information required by the edge server based on the failure cause.

30. The edge server of claim 28,
wherein the edge server is one of an edge configuration server (ECS) or an edge enabler server (EES).

31. The edge server of claim 28,
wherein, in case that the edge server is an edge configuration server (ECS), the service request is one of a service provisioning request or a service provisioning subscription request.

32. The edge server of claim 28,
wherein, in case that the edge server is an edge enabler server (EES), the service request is one of an edge application server (EAS) discovery or a EAS discovery subscription request.
